(19) United States
(12) Patent Application Publication
(10) Pub. No.: US 2006/0027527 A1
(43) Pub. Date: Feb. 9, 2006

(54) Method of producing perpendicular magnetic recording disk

(75) Inventors: Yasuyuki Yokota, Tokyo (JP); Hisatomo Ohno, Tokyo (JP); Noriyuki Kumasaka, Tokyo (JP)

Correspondence Address: BEYER WEAVER & THOMAS LLP, P.O. BOX 70250, OAKLAND, CA, 94612-0250, US

(73) Assignee: NIHON Microcoating Co., Ltd.

(21) Appl. No.: 11/193,105

(22) Filed: Jul. 29, 2005

(30) Foreign Application Priority Data
Aug. 6, 2004 (JP) 2004-231399

(51) Int. Cl. B44C 1/22; C23F 1/00

(52) U.S. Cl. 216/22; 216/88; 216/89

(57) ABSTRACT

A perpendicular magnetic recording disk is produced by polishing to make smoother both surfaces of a substrate and sequentially forming a soft magnetic layer, a perpendicular recording layer and a protective layer on each of the polished surfaces of the substrate. The surfaces of the soft magnetic layers are polished by a fixed particle polishing method to be made smoother, and the perpendicular recording layers is formed on the smoothed surfaces of the soft magnetic layers either directly or with an intermediate layer in between.

Priority is claimed on Japanese Patent Application 2004-231399 filed Aug. 6, 2004.

### BACKGROUND OF THE INVENTION

This invention relates to a method of producing a perpendicular magnetic recording disk.

Data processors for recording and reproducing data such as characters, images and sounds are coming to be installed not only in computers but also in apparatus such as televisions, cameras and telephones. Such data processors are now required to have improved processing capabilities (with increased recording capacities) and accuracy in reproduction and to be smaller in size. Data are magnetically recorded on a magnetic recording medium and reproduced therefrom by means of a magnetic head of the data processor.

As disclosed in http://www.tr1.ibm.com/projects/perpen/(“Perpendicular Magnetic Recording”, IBM Tokyo Research Laboratory) and http://spin.pe.titech.acjp/hp/research/nfts2/(“Production of Co—Cr High-Density Perpendicular Magnetic Recording Medium”, Nakagawa Group, Department of Electronic Physical Engineering, Tokyo Engineering University), perpendicular magnetic recording disks are now under consideration as a magnetic recording medium. Such disks are produced by sequentially forming a soft magnetic layer with high magnetic permeability, a perpendicular recording layer and a protective layer on the surface of an aluminum substrate with Ni—P plating or of a glass substrate (hereinafter summarily referred to as a substrate) by using a thin film technology such as sputtering. The perpendicular recording layer comprises an assembly of columnar crystalline elements having a segregated structure by composition separation of a magnetic layer material deposited on the surface of a high-temperature substrate, and each crystalline element is comprised of a ferromagnetic columnar center part extending in a direction perpendicular to the surface of the substrate and a non-magnetic surrounding part formed around this center part. These columnar crystalline elements form the recording bits that are magnetizable in the direction perpendicular to the surface of the substrate.

Because a perpendicular magnetic layer is thus formed with columnar crystalline elements extending perpendicularly to the surface of the substrate, the surface of a perpendicular magnetic recording disk is particularly required to be smooth such that the average surface roughness will be 2.0 Å or less and to be flat such that the surface height variations will be 1 Å or less with wavelengths in the range of 0.05 mm-0.5 mm in both radial and circumferential directions.

In general, the surface of a substrate is polished to be smooth and flat by a free particle polishing method. The free particle polishing method may be roughly divided into the lapping plate polishing method and the tape polishing method. By the lapping plate polishing method, a substrate is sandwiched between a pair of upper and lower lapping plates each having a pad made of a woven cloth, a non-woven cloth or a foamed material pasted on its surface and the lapping plates are rotated in mutually opposite directions while polishing slurry is introduced into the space in between. By the tape polishing method, the substrate itself is rotated, polishing slurry is supplied to its surface and a tape of woven cloth, unwoven cloth, flocked cloth (having hair known as piles attached to the surface) or raised cloth is caused to run while being pressed onto the surface of the substrate. The polishing slurry is made of abrading particles and a dispersant. Japanese Patent Application Tokugan 2004-129140 (filed Apr. 26, 2004 by the inventors herein) disclosed that a substrate satisfying the aforementioned requirement can be obtained by using abrading particles comprising artificial diamond particles with diameters less than 50 nm, say, obtained by a shock wave method.

The increase in the capacity for data recording and the accuracy in reproduction both depend largely on the distance of separation between the surface of the magnetic disk (perpendicular magnetic recording disk) and the magnetic head. Since data are recorded by outputting a magnetic signal from the magnetic head to form small magnets on the magnetic layer (perpendicular magnetic layer) and reproduced by reading the magnetic signals from these small magnets by means of the magnetic head, an increased distance of separation between the surface of the magnetic disk and the magnetic head means that the magnetic signals outputted from the magnetic head are dispersed more such that the quantity of recording per unit area (the recording density or recording capacity) is reduced. Thus, in order to increase the capacity of data recording and to improve the accuracy of reproduction, the distance of separation between the surface of the magnetic disk and the magnetic head must be made smaller. Moreover, the magnetic disk can be made smaller if the recording quantity per unit area is increased. For this reason, the distance of separation between the surface of the magnetic disk and the magnetic head is now required to be 15 nm or less.

Since a soft magnetic layer of thickness 0.1 μm-3 μm is formed by a thin-film technology such as sputtering or plating, however, it takes a long time for the formation of the film layer, and it is likely that epitaxial growth of crystals occurs and foreign particle objects may become attached during the formation of the thin film. If the soft magnetic layer and the protective layer are sequentially formed on the surface of such a soft magnetic layer, protrusions and indentations caused by such epitaxial growth and attached particles are formed on the surface of the perpendicular magnetic recording disk, and it is not possible to stably maintain the distance between the surface of the perpendicular magnetic recording disk and the magnetic head to be less than 15 nm.

By the lapping plate (free particle) polishing method, furthermore, it is difficult to polish the surface of a soft magnetic layer at a high level of precision, and since the substrate is washed after it is removed from the lapping plates, it takes time until the washing can be started and the soft magnetic layer comprising a metallic film with low resistance against corrosion becomes corroded.

### SUMMARY OF THE INVENTION

It is therefore an object of this invention to provide a method of producing a perpendicular magnetic recording disk with a flat and smooth surface.

According to this invention, a perpendicular magnetic recording disk is produced by polishing to make smooth both surfaces of a disk-shaped substrate and sequentially forming a soft magnetic layer, a perpendicular recording layer and a protective layer on each of the polished substrate surfaces. An aluminum substrate with its surfaces treated with alumite or subjected to Ni—P plating or a glass substrate is used as the substrate, and the surfaces of such a substrate are polished by a known polishing method or by the method disclosed in aforementioned Japanese Patent Application Tokugan 2004-129140.

The soft magnetic layers are formed on the polished surfaces of the substrate either directly or with a foundation layer in between. The soft magnetic layers are made of a material with a high magnetic permeability, comprising according to this invention an amorphous alloy containing at least one material selected from the group consisting of Fe, Co and Ni and at least one material selected from the group consisting of Nb, Zr, Cr, Ta, Mo, Ti, B, C, P and Si. The soft magnetic layer may also comprise an alloy containing at least one material selected from the group consisting of Fe, Co and Ni and at least one material selected from the group consisting of Pt, Zr, Nb, Ti, Cr, Ru and Si.

In order to achieve the aforementioned object of this invention, the surfaces of the soft magnetic layers are polished and made smoother such that protrusions formed on them by abnormal growth and debris particles attached to them can be removed, and the perpendicular recording layers are formed on these smoothed surfaces of the soft magnetic layers either directly or with an intermediate layer in between.

Each of these layers is formed by a known thin film technology such as sputtering and plating, and the soft magnetic layers formed on both surfaces of the substrate are polished by a so-called fixed particle polishing method comprising the steps of rotating the substrate and pressing a polishing tape onto each of the surfaces of the soft magnetic layers. Each polishing tape is pressed onto the surface of a soft magnetic layer through a pad or a roller. Compressed air may be blown to the back surface of the polishing tape. Each pad is moved reciprocatingly in a radial direction of the substrate. The polishing tapes may be supplied continuously in the radial direction of the substrate or may be kept in a stationary condition.

The polishing tape comprises a plastic film and a polishing layer formed on a surface of the plastic film. The polishing layer has abrading particles fastened with a resin binder. The plastic film has a thickness of 5 μm-100 μm, and the abrading particles are of one or more materials selected from the group consisting of aluminum oxide, diamond, silica, cerium oxide, ion oxide, chromium oxide and silicon carbide with average diameter of 0.02 μm-5 μm. The resin binder is a polyester binder or a polyurethane binder.

After this fixed particle polishing process, a tape made of a foamed material or a woven, non-woven, flocked or raised cloth material is pressed onto the surface of each soft magnetic layer such that debris particles that came to be attached during the fixed particle polishing process can be removed. Debris particles may be removed also by blowing water or air onto the surfaces of the soft magnetic layers.

By a method of this invention, the surfaces of the soft magnetic layers are made smoother and hence the protrusions formed thereon by abnormal growth and debris particles that came to be attached can be removed such that a perpendicular magnetic recording disk with smooth and flat surfaces can be produced. The soft magnetic layers do not become rusty because they are metallic alloy layers.

### BRIEF DESCRIPTION OF THE DRAWINGS

FIGS. 1A and 1B are each a sectional view of a perpendicular magnetic recording disk.

FIG. 2 is a schematic drawing of a double-surface polisher.

### DETAILED DESCRIPTION OF THE INVENTION

This invention relates to a method of producing a perpendicular magnetic recording disk.

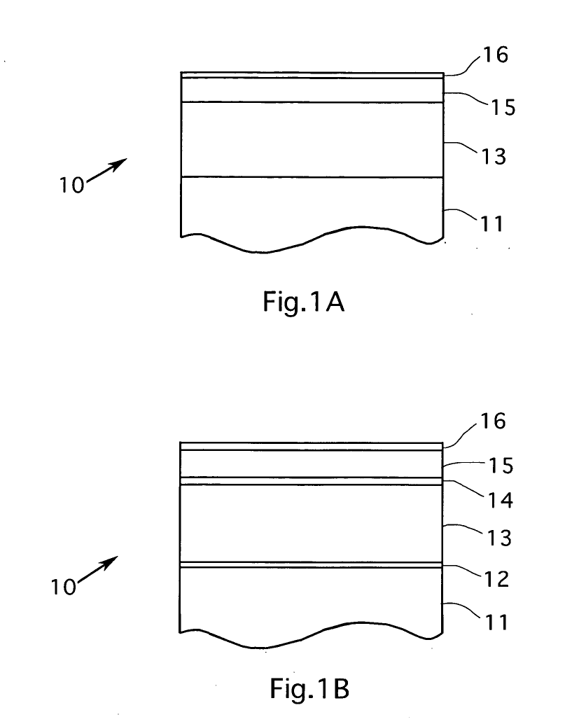

FIGS. 1A and 1B each show a perpendicular magnetic recording disk 10, produced by polishing both surfaces of a disk-shaped substrate 11 and sequentially forming thereon a soft magnetic layer 13, a perpendicular recording layer 15 and a protective layer 16. An aluminum substrate with its surfaces treated with alumite or subjected to Ni—P plating or a glass substrate is used as the substrate 11.

Both surfaces of the substrate 11 are polished to be smooth by a conventional free particle polishing method as explained above. For polishing slurry, particles of one or more kinds selected from the group consisting of aluminum oxide, silicon oxide, iron oxide and cerium oxide are used as the abrading particles, and water or a water-based aqueous solution with glycol added is used as the dispersant. If a glass substrate is used as the substrate 11, a reaction liquid that reacts chemically with glass such as potassium hydroxide may also be added to the polishing slurry. If an aluminum substrate with Ni—P plating is used, the surface of this non-magnetic Ni—P film may be polished to be smooth or a magnetic Ni—P film may be further formed over this non-magnetic Ni—P film, the surface of this magnetic Ni—P film being polished to be smooth and a soft magnetic layer being directly formed thereon.

It is preferable that the average surface roughness of the surfaces of the substrate after the polishing process be 2 Å or less. After the polishing process, both surfaces of the substrate are washed well with water and then dried.

The soft magnetic layer 13 may be directly formed by a known thin-film technology such as sputtering or plating on both surfaces of the substrate 11 as shown in FIG. 1A. Alternatively, a foundation layer 12 may be formed on each surface of the substrate 11 and the soft magnetic layer 13 may be formed on the surface of each foundation layer 12 as shown in FIG. 1B. The foundation layer 12 is made of a material selected from the group consisting of Ti, Cr and their alloys and is formed for the purpose of making up for the topological unevenness on both surfaces of the polished substrate 11. In order to eliminate the spike noise from the soft magnetic layer 13 to be formed thereon, a pinning layer made of a material such as Co—Sm and Co—Pt may be formed on both surfaces of the substrate 11 as the foundation layer 12.

The soft magnetic layer 13 is made of a material with high magnetic permeability, comprising at least one material selected from Fe, Co and Ni and an amorphous alloy, such as Co—Nb—Zr, Co—Ta—Zr, Co—Ti—Si, Co—Mo—Zr, Fe—Co—P, Ni—P, Fe—Ni—P, Fe—B and Fe—Si, containing at least one material selected from the group consisting of Nb, Zr, Cr, Ta, Mo, Ti, B, C, P and Si. The soft magnetic layer 13 may also be made of a metal alloy, such as Ni—Fe, Fe—Co—Ni, Fe—Co—Ni—Ru, Co—Ni—Pt, Co—Ni—Cr and Fe—Si—Ru, containing one material selected from the group consisting of Fe, Co and Ni and another material selected from the group consisting of Pt, Zr, Nb, Ti, Cr, Ru and Si. The thickness of the soft magnetic layer 13 is in the range of 0.2 μm-3 μm. According to this invention, the surface of this soft magnetic layer 13 is polished to be smooth such that the average surface roughness will be 2 Å or less.

The perpendicular recording layer 15 may be formed by using a known thin-film technology such as sputtering and plating directly on the surface of the soft magnetic layer 13 which has thus been made smooth, as shown in FIG. 1A. The perpendicular recording layer 15 may also be formed on the surface of an intermediate layer 14 which is formed by using a known thin-film technology such as sputtering and plating on the surface of the soft magnetic layer 13, as shown in FIG. 1B. The intermediate layer 14 (also referred to as a crystalline element control layer) is for the purpose of orienting the crystalline elements inside the perpendicular recording layer 15 in the direction perpendicular to the surface of the substrate 11 and comprises a material selected from Co—Cr, Co—Pt, Co—Cr—Pt, Co—Ni and Co—O. The thickness of the perpendicular recording layer 15 is within the range of 10 nm-100 nm.

The protective layer 16 is formed directly on the surface of the perpendicular recording layer 15 by a known thin-film technology such as sputtering and plating, as shown in FIGS. 1A and 1B. The protective layer 16 is a diamond-like carbon film. Its surface is subjected to a cleaning process and processed with a lubricant such that a perpendicular magnetic recording disk 10 according to this invention is produced.

The surface of the soft magnetic layer 13 formed on each surface of the substrate 11 is polished to be smooth by a fixed particle polishing method. This fixed particle polishing method is carried out by rotating the substrate 11 and pressing a polishing tape onto the surface of the soft magnetic layer 13 on each surface of the substrate 11. The polishing tape is pressed onto the surface of each soft magnetic layer 13 through a pad or a roller while compressed air is blown onto the back surface of the polishing tape.

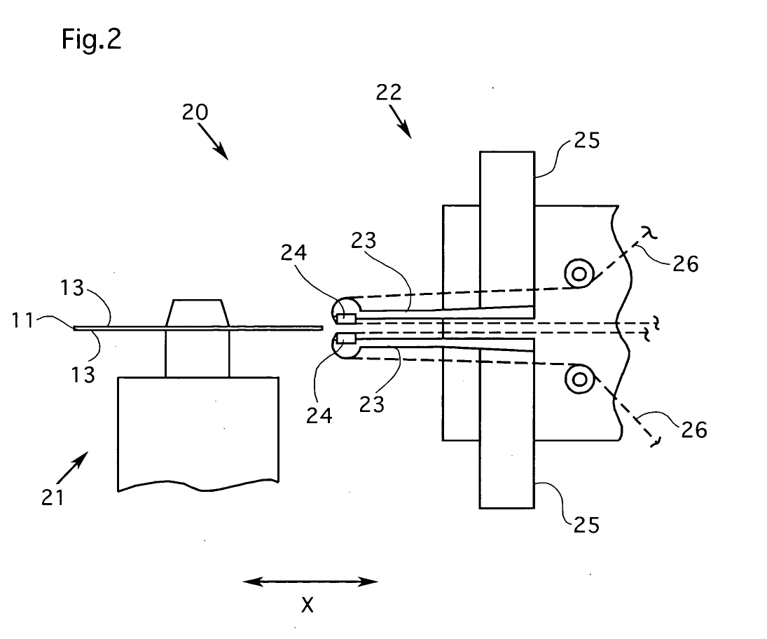

A double-surface polisher 20 shown in FIG. 2 (as disclosed in Japanese Patent Publication 2001-162504) may preferably be used for this purpose. This double-surface polisher 20 comprises a spindle 21 for attaching the substrate 11, a polishing head 22 for polishing both surfaces of the substrate 11 and a means (not shown) for causing the polishing head 22 to undergo a reciprocating motion in the radial direction (shown by double headed arrow X) of the substrate 11 affixed to the spindle 21. The polishing head 22 has a pair of arms 23 arranged to face opposite each other, having rubber pads 24 fastened to the tips of these arms 23 so as to face each other. The double-surface polishing of the substrate 11 is carried out by attaching the substrate 11 to the spindle 21 to rotate it, causing polishing tapes 26 (shown by broken lines) to travel on the rubber pads 24, activating pressing means 25 to press the polishing tapes 26 through the rubber pads 24 onto the surfaces of the soft magnetic layers 13 on both surfaces of the substrate 11 and simultaneously causing the polishing head 22 to undergo a reciprocating motion in the radial direction of the substrate 11 shown by arrow X.

The rubber pads 24 may be replaced by rubber rollers (not shown) rotatable in the direction of travel of the polishing tapes 26 and attached at the tips of the arms 23 such that the polishing tapes 26 will be pressed onto the surfaces of the soft magnetic layers 13 through these rubber rollers. Alternatively, air openings may be provided at the tips of the arms 23 such that compressed air caused to blow out therethrough onto the back surfaces of the polishing tapes 26 will cause the polishing tapes 26 to be pressed onto the surfaces of the soft magnetic layers 13.

The polishing tape 26 comprises a plastic film and a polishing layer formed on the surface of this plastic film with abrading particles fastened with a resin binder. The thickness of the plastic film is within the range of 5 μm-100 μm and the abrading particles are particles of one or more materials selected from aluminum oxide, diamond, silica, cerium oxide, ion oxide, chromium oxide and silicon carbide with average diameter of 0.02 μm-5 μm. The resin binder is a polyester binder or polyurethane binder.

The conditions for the fixed particle polishing method are explained next. The rotational speed of the substrate 11 is within the range of 200 rpm-200 rpm. If the rotational speed is less than 200 rpm, the number of scratches formed on the surface of the soft magnetic layer 13 increases on the inner peripheral portion of the substrate 11. If the rotational speed exceeds 2000 rpm, on the other hand, the surface of the soft magnetic layer 13 becomes rough.

The hardness of the pad 24 is within the range of 15 duro-50 duro. Rubber pads with hardness within this range are conveniently used.

The pressure with which the polishing tape 26 is compressed is within the range of 30 gf-200 gf If this pressure is less than 30 gf, particles that become attached to the surface of the soft magnetic layer become difficult to remove. If this pressure exceeds 200 gf, on the other hand, the number of scratches formed on the surface of the soft magnetic layer increases.

The polishing time is within the range of 2 seconds-30 seconds. If the polishing time exceeds 30 seconds, the surface undulation of the soft magnetic layer 13 on the inner and outer peripheral portions of the substrate 11 becomes large.

While the polishing tapes 26 are pressed onto the surfaces of the soft magnetic layers 13 on both surfaces of the substrate 11, the polishing tapes 26 may be made to continuously travel in the radial direction but it is preferable to keep the polishing tapes 26 stationary because the number of scratches can be reduced by keeping the polishing tapes 26 stationary, instead of causing them to travel continuously, while they are being pressed onto the surfaces of the substrate if the polishing time is relatively short.

As for the direction of the polishing, it is preferable to move reciprocatingly (as indicated by arrow X) from the outer periphery to the inner periphery and to pass to the outer periphery. It is because waste materials such as polishing debris particles can be more effectively removed from the outer periphery of the substrate 11 and to reduce the number of debris particles remaining on the surfaces of the soft magnetic layers 13.

After this fixed particle polishing process, a tape (not shown) made of a foamed material or a woven, non-woven, flocked or raised cloth material is pressed onto the surface of each soft magnetic layer 13 on the substrate 11 for wiping off debris particles therefrom. This operation may be carried out by replacing the polishing tapes 26 on the polisher 20 with the wiping tapes as described above or by removing the substrate 11 from the polisher 20 and using another polisher of a prior art type. Debris particles may be removed also by blowing water or air onto the surfaces of the soft magnetic layers 13 on both surfaces of the substrate 11.

The invention is described next by way of test examples.

As Test Example 1, a perpendicular magnetic recording disk was prepared by first making both surfaces of a glass substrate of 2.5 inches in diameter smooth and flat by a free particle polishing method, washing them with water and drying them. The free particle polishing process was carried out by rotating the substrate, supplying polishing slurry having abrading particles of artificial diamond with diameters less than 50 nm dispersed in water to the surfaces of this substrate, pressing woven cloth tapes on these surfaces and causing them to run. The average surface roughness (Ra) of the surfaces of the glass substrate after the polishing process was less than 1.5 Å and the flatness in terms of surface height variations (waviness Wa) was 1.0 Å or less with wavelengths in the range of 0.05 mm-0.5 mm. Next, a soft magnetic layer of thickness 0.2 μm made of Co—Nb—Zr alloy was formed on each surface of this glass substrate by sputtering and after the surfaces of these soft magnetic layers were polished to become smooth, a perpendicular recording layer and a protective layer were sequentially formed by sputtering on the surface of each soft magnetic layer to obtain a perpendicular magnetic recording disk.

The surfaces of the soft magnetic layers were subjected to a fixed particle polishing process by using the polisher shown in FIG. 2 by using polishing tapes each having a polishing layer of thickness 10 μm with abrading particles of aluminum oxide with average diameter 0.5 μm (WA10000-25FMY-B produced by MIPOX Corporation) affixed to the surface of a plastic film of thickness 24 μm made of polyethylene terephthalate by a polyester resin binder. The average surface roughness of these polishing tapes was 0.22 μm.

Table 1 shows the details of the fixed particle polishing process.

TABLE 1

| | |
|---|---|
| Rotational speed of the substrate | 1000 rpm |
| Pressure on polishing tapes | 40 gf |
| Hardness of pads | 25 duro (rubber pad) |
| Traveling speed of polishing | Zero while the tapes were pressed |
| tapes | |
| Polishing time | 5 seconds |
| Direction of polishing | From outer periphery to inner periphery |
| | and passing to outer periphery |

The numbers of attached debris particles and protrusions, the number of scratches, the average surface roughness (Ra) and the surface waviness (Wa) of the surfaces of the soft magnetic layer before and after the polishing process were measured. The numbers of debris particles, protrusions and scratches were measured by using an optical surface analyzer (Trade name: OSA5100 produced by Candela Instruments Corporation) by projecting a laser beam on the surface of the soft magnetic layer of the glass substrate rotating at a speed of 10000 rpm in the radial direction. The average surface roughness (Ra) and the surface waviness (Wa) (surface height variations with wavelengths in the range of 0.05 mm-0.5 mm) were measured by using a white-light microscope (Trade name: New View 5020 produced by Zygo Corporation) in an arbitrary area of 0.87 mm×0.87 mm of the surface of the soft magnetic layer.

The results of measurements are shown in Table 2. Each number shown in Table 2 is an average of values obtained from 10 glass substrates having soft magnetic layers formed on both surfaces under the same conditions. In Table 2, Surface A means one of the surfaces and Surface B means the other surface.

TABLE 2

| | Before polishing | | After polishing | |
|---|---|---|---|---|
| | Surface A | Surface B | Surface A | Surface B |
| Debris particles | 241 | 195 | 8 | 5 |
| Scratches | 22 | 17 | 3 | 2 |
| Ra | 1.88 Å | 1.81 Å | 1.79 Å | 1.74 Å |
| Wa | 1.08 Å | 1.20 Å | 1.02 Å | 0.95 Å |

Table 2 clearly shows that the number of debris particles and the number of scratches were reduced significantly and the average surface roughness and the surface waviness were improved by the polishing according to this invention.

Next, as Test Examples 2-12, perpendicular magnetic recording disks were prepared as explained above for Test Example 1 except the conditions of fixed particle polishing were changed as shown in Table 3. The traveling speed of the polishing tape and the direction of polishing were the same as in Test Example 1.

In addition, as Comparison Examples 1-8, perpendicular magnetic recording disks were prepared as explained above for Test Examples 2-12 except the conditions of fixed particle polishing were changed as also shown in Table 3.

TABLE 3

| | Rotational | | | |
|---|---|---|---|---|
| | speed of | Pressure | Pad hardness | Polishing |
| | substrate | (gf) | (duro) | time (sec) |
| Test Example: | | | | |
| 2 | 200 | 40 | 25 | 5 |
| 3 | 2000 | 40 | 25 | 5 |
| 4 | 1000 | 30 | 25 | 5 |
| 5 | 1000 | 100 | 25 | 5 |
| 6 | 1000 | 200 | 25 | 5 |
| 7 | 1000 | 60 | 15 | 5 |
| 8 | 1000 | 60 | 25 | 5 |
| 9 | 1000 | 60 | 50 | 5 |
| 10 | 1000 | 40 | 25 | 5 |
| 11 | 1000 | 40 | 25 | 20 |
| 12 | 1000 | 40 | 25 | 30 |
| Comparison | | | | |
| Example: | | | | |
| 1 | 150 | 40 | 25 | 5 |
| 2 | 2500 | 40 | 25 | 5 |
| 3 | 1000 | 20 | 25 | 5 |
| 4 | 1000 | 250 | 25 | 5 |
| 5 | 1000 | 60 | 10 | 5 |
| 6 | 1000 | 60 | 60 | 5 |
| 7 | 1000 | 60 | 25 | 1 |
| 8 | 1000 | 40 | 25 | 40 |

Comparisons were made among the samples of Test Examples 2-12 and Comparison Examples 1-8 regarding the number of debris particles and protrusions, the number of scratches, the average surface roughness (Ra) and the surface waviness (Wa). The same optical surface analyzer (Trade name: OSA5100 produced by Candela Instruments Corporation), as in Test Example 1, was used for the measurement of the numbers of debris particles, protrusions and scratches while laser light was projected in the radial direction on the surface of the soft magnetic layer of each glass substrate rotating at the rotational speed of 10000 rpm. The same white-light microscope (Trade name: New View 5020 produced by Zygo Corporation), as in Test Example 1, was used for the measurement of the average surface roughness (Ra) and the surface waviness (Wa) (surface height variations with wavelengths in the range of 0.05 mm-0.5 mm) in an arbitrary area of 0.87 mm×0.87 mm of the surface of the soft magnetic layer.

The results of the comparison are shown in Table 4. These results were obtained from five samples each having a soft magnetic layers formed on both surfaces under the same conditions. The evaluations were made as follows:

For debris and protrusions:

| | |
|---|---|
| A: | Less than 10 on all samples |
| B: | 10 or more on one or more samples |
| C: | 10 or more on all samples |

For scratches:

| | |
|---|---|
| A: | Less than 5 on all samples |
| B: | 5 or more on one or more samples |
| C: | 5 or more on all samples |

For average surface roughness:

| | |
|---|---|
| A: | Less than 2 Å on all samples |
| B: | 2 Å or greater on one or more samples |
| C: | 2 Å or greater on all samples |

For surface waviness:

| | |
|---|---|
| A: | Less than 2 Å on all samples |
| B: | 2 Å or greater on one or more samples |
| C: | 2 Å or greater on all samples |

Table 4 clearly shows that the surface of a soft magnetic layer can be reliably made smooth and flat by a polishing method according to this invention.

TABLE 4

| | | | Average | |
|---|---|---|---|---|
| | Debris and | | surface | Surface |
| | protrusions | Scratches | roughness | waviness |
| Test Example: | | | | |
| 2 | A | A | A | A |
| 3 | A | A | A | A |
| 4 | A | A | A | A |
| 5 | A | A | A | A |
| 6 | A | A | A | A |
| 7 | A | A | A | A |
| 8 | A | A | A | A |
| 9 | A | A | A | A |
| 10 | A | A | A | A |
| 11 | A | A | A | A |
| 12 | A | A | A | A |
| Comparison Example: | | | | |
| 1 | B | B | B | A |
| 2 | A | A | C | B |
| 3 | C | A | C | A |
| 4 | A | C | B | B |
| 5 | C | A | B | B |
| 6 | A | C | B | A |
| 7 | C | A | B | A |
| 8 | A | C | A | B |

What is claimed is:

1. A method of producing a perpendicular magnetic recording disk, said method comprising the steps of:
polishing to make smoother both surfaces of a substrate and sequentially forming a soft magnetic layer, a perpendicular recording layer and a protective layer on each of the polished surfaces of said substrate, said soft magnetic layer being formed on the polished surface of said substrate either directly or with a foundation layer in between; and
polishing to make smoother the surfaces of said soft magnetic layers, said perpendicular recording layers being formed on said smoothed surfaces of said soft magnetic layers either directly or with an intermediate layer in between.

2. The method of claim 1 wherein the surfaces of said soft magnetic layers are polished by a fixed particle polishing method.

3. The method of claim 2 wherein said fixed particle polishing method comprises the steps of:
rotating said substrate; and
pressing a polishing tape onto each of the surfaces of said soft magnetic layers.

4. The method of claim 3 wherein the polishing tape is pressed onto said each surface through a pad and said fixed particle polishing method further comprises the step of causing said pad to move reciprocatingly in a radial direction of said substrate.

5. The method of claim 3 wherein said polishing tape comprises a plastic film and a polishing layer formed on a surface of said plastic film, said polishing layer having abrading particles fastened with a resin binder, said plastic film having a thickness of 5 μm-100 μm, said abrading particles being of one or more materials selected from the group consisting of aluminum oxide, diamond, silica, cerium oxide, ion oxide, chromium oxide and silicon carbide with average diameter of 0.02 μm-5 μm, said resin binder being a polyester binder or a polyurethane binder.

6. The method of claim 1 wherein said soft magnetic layer comprises an amorphous alloy containing at least one material selected from the group consisting of Fe, Co and Ni and at least one material selected from the group consisting of Nb, Zr, Cr, Ta, Mo, Ti, B, C, P and Si.

7. The method of claim 1 wherein said soft magnetic layer comprises an alloy containing at least one material selected from the group consisting of Fe, Co and Ni and at least one material selected from the group consisting of Pt, Zr, Nb, Ti, Cr, Ru and Si.
